(19) United States
(12) Patent Application Publication
(10) Pub. No.: US 2007/0072639 A1
(43) Pub. Date: Mar. 29, 2007

(54) FLIGHT RECORDER WIRELESS INTERFACE

(75) Inventors: Wendell A. Frost, Renton, WA (US); Duncan Schofield, Bellevue, WA (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/162,976

(22) Filed: Sep. 29, 2005

(51) Int. Cl. H04M 1/00

(52) U.S. Cl. 455/550.1

(57) ABSTRACT

Methods and systems for wirelessly offloading data recorded on a flight recorder. In one embodiment, a method of offloading data recorded on a flight recorder includes determining whether to enable a wireless transmitter and wirelessly transmitting previously stored data on the flight recorder via the wireless transmitter according to the determination. In one aspect, wireless transmission is determined by wireless parameters, such as weight on wheels, air speed, ground speed, engine speed, open compartments and sensed forces or other airplane parameters made available to the flight recorder. Wireless transmission may be initiated either manually or automatically.

### BACKGROUND OF THE INVENTION

Crash survivable flight recorders are an invaluable source of information for crash investigation. The recorders by design are crashproof and fireproof; the information stored in protected memory includes airplane flight data, crew voice data, datalink messages and cockpit ambient audio. The current crash survivable flight recorders are generally installed in the tail or rear of airplanes, behind panels that must be removed for access to the recorder for direct data download. Gaining access to the stored flight data may be a labor-intensive maintenance task and may require separate access points, connectors, or wiring added to the airplane installation. Therefore, there exists a need for a convenient method for routinely accessing stored flight data.

### BRIEF SUMMARY OF THE INVENTION

The present invention provides a method and apparatus for wirelessly offloading data from a flight recorder. In one embodiment, a method of offloading data recorded on a flight recorder includes determining whether to enable a wireless transmitter and wirelessly transmitting previously stored data on the flight recorder via the wireless transmitter according to the determination.

In one aspect, wireless transmission is determined by evaluation of airplane-supplied parameters, such as weight on wheels, air speed, ground speed, engine speed, open compartments and sensed forces. Wireless transmission may be initiated either manually or automatically.

### BRIEF DESCRIPTION OF THE SEVERAL VIEWS OF THE DRAWING

The preferred and alternative embodiments of the present invention are described in detail below with reference to the following drawings.

FIG. 1 illustrates a schematic view of a flight recorder formed in accordance with an embodiment of the present invention;

FIG. 2 illustrates a perspective view of a flight recorder formed in accordance with another embodiment of the present invention;

FIG. 3 illustrates a partial front view of the flight recorder of FIG. 2;

FIG. 4 illustrates a perspective view of a flight recorder formed in accordance with yet another embodiment of the present invention;

FIG. 5 illustrates a partial front view of the flight recorder of FIG. 4; and

FIG. 6 is a flow diagram of a process for wirelessly recording flight data based on the embodiments as shown in FIGS. 1-5.

### DETAILED DESCRIPTION OF THE INVENTION

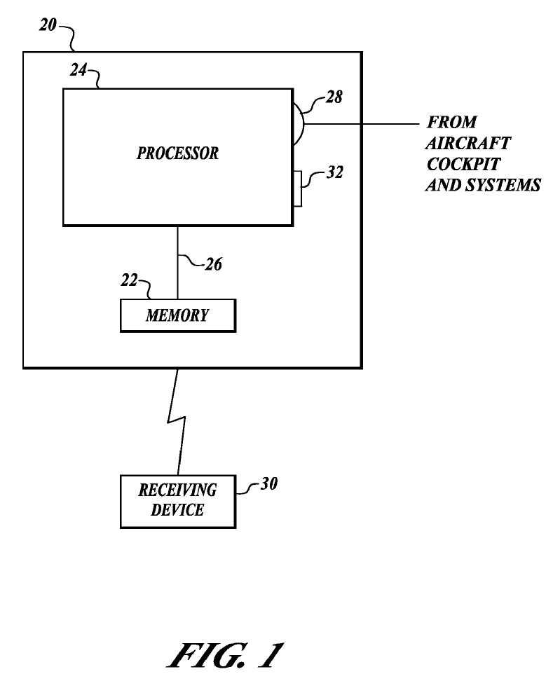

FIG. 1 illustrates a schematic view of a flight recorder 20 with wireless interface formed in accordance with an embodiment of the present invention. In one particular embodiment, the flight recorder 20 records data entering the flight recorder 20 at a data input receiver 28. The received data includes cockpit audio data, such as flight crew voices, radio transmissions and reception, warnings, alerts, static, periods of silence and other audible conditions. The flight data also includes instrument readings, such as altitude, hydraulic fluid pressure, fuel levels, speed, engine RPM, cabin pressure and so forth. The data may be derived from aircraft cockpit instruments and other suitable systems.

In one embodiment, a processor 24 is coupled to the data input receiver 28 to receive the data and determines whether to enable wireless data offloading by engaging a wireless component 32. Data is stored to a crash-survivable memory unit 22 and overwritten as the memory unit 22 becomes full. The processor 24 includes a circuit card assembly (CCA) upon which it resides. After determining whether to enable wireless activation, the wireless component 32 employs a wireless data networking protocol used to connect to a network or external receiving device 30. In one embodiment, the receiving device 30 includes a graphical user interface or similar control software program for allowing an operator to control retrieval and replay of the data stored in the recorder 20.

Conditions for enabling wireless data offloading include aircraft parameters such as, weight on the wheels, speed below certain air or ground speed limit, an open door, engine speed, and forces on the aircraft. The wireless component 32 is engaged when wireless data offloading is enabled. In one embodiment, wireless data offloading is initiated manually and interactively offloaded, as will be further described in reference to FIG. 6. If wireless data offloading is not enabled, data is not offloaded and the wireless component 32 is disabled by disconnecting its power.

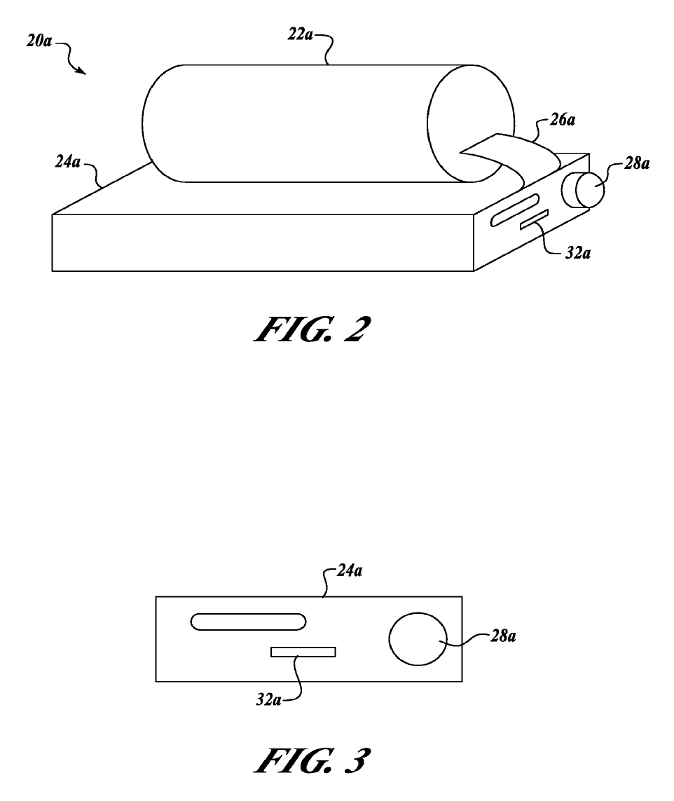

FIGS. 2 and 3 illustrate a perspective view of an example flight recorder 20a formed in accordance with an embodiment of the present invention. The flight recorder 20a includes a memory unit 22a, a processor 24a, an internal interconnecting circuit 26a and an external interconnecting circuit 28a to receive data from the aircraft. The flight recorder 20a also includes a wireless radio component 32a that employs a wireless protocol, such as an 802.11 Wi-Fi, Institute of Electrical and Electronics Engineers (IEEE) specification, Global System Mobile Communication general packet radio service (GSM-GPRS), or a Code Division Multiple Access (CDMA). The wireless component 32a can be embodied in a Personal Computer Memory Card International Association (PCMCIA) card, PC card, or similar device that is received within a slot. In another embodiment, the processor 24a includes an encryption component for encrypting data before transmission via the wireless component 32a.

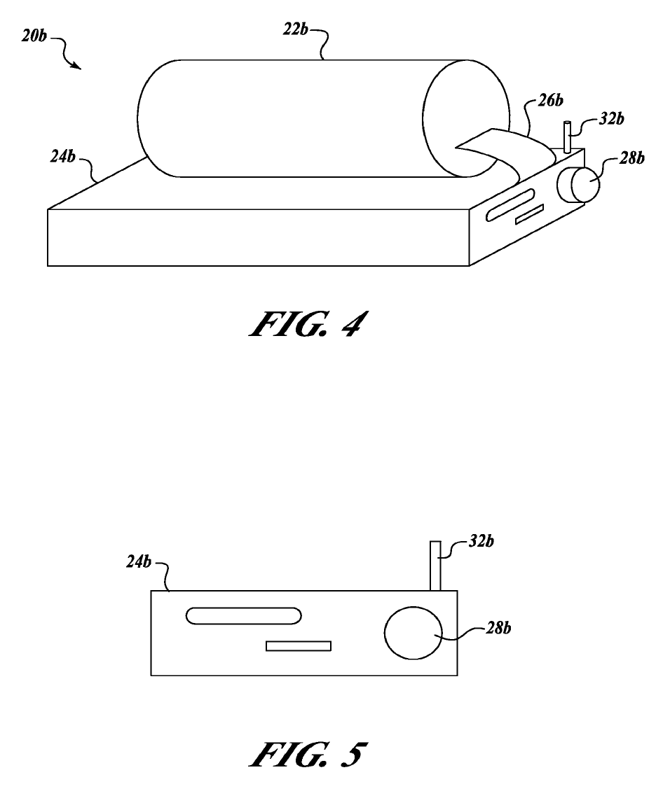

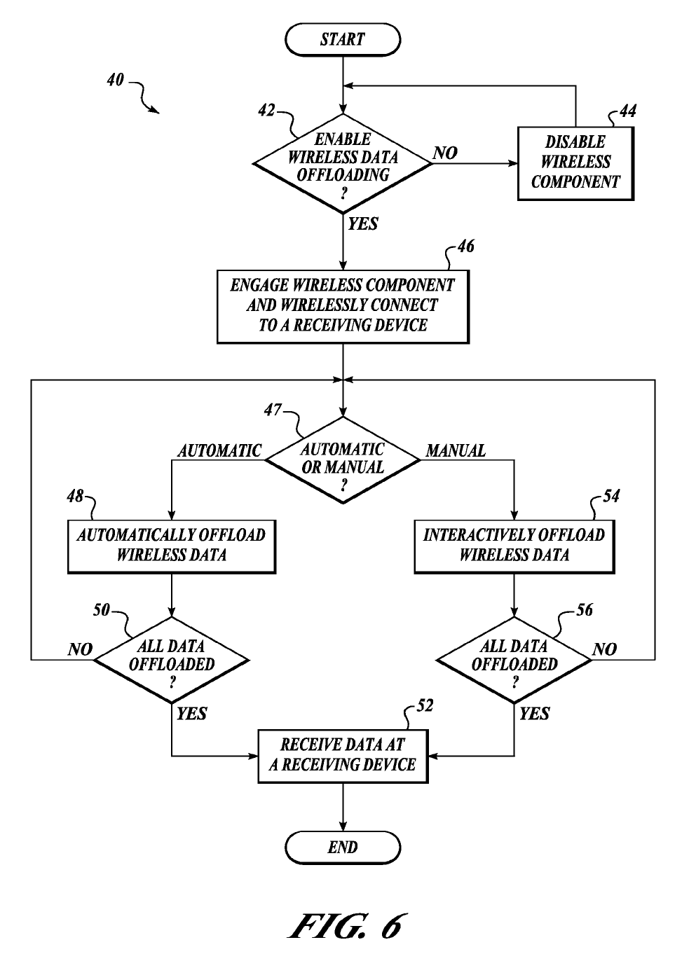

FIGS. 4 and 5 illustrate a perspective view of an example flight recorder 20b formed in accordance with yet another embodiment. The flight recorder 20b includes a wireless component 32b that includes an antenna. The antenna receives stored data as a transmission signal generated by a signal generator (not shown) that is in communication with a processor 24b.

FIG. 6 is a block diagrammatic view of a method 40 for wirelessly offloading recorded flight data. At a decision block 42, a determination is made whether to enable wireless data offloading, as initiated by airplane parameters, such as, weight on the wheels, speed below certain air or ground speed limit, an open door, engine speed, and forces on the aircraft. If a determination is made not to enable wireless data offloading, the wireless component is disabled at a block 44 and power to the wireless component is disconnected. If a determination is made to enable wireless data offloading, the wireless component is engaged and a network connection is made at a block 46. The creation of a network connection may be performed manually or automatically, such as by searching for wireless receiving devices or routers within range.

At a decision block 47, manual or automatic offloading is determined. This step depends upon how the system is configured. If the system is configured for automatic offloading, then at a block 48, data is automatically wirelessly transmitted. If at a decision block 50, all the data is offloaded, then at a block 52, the automatically transmitted data is received by a receiving device, such as a laptop, palm device, cell phone, or a data analysis system in communication with a computer wireless router located at a fixed location, such as a gate.

If at a decision block 47, a determination was made to manually download the data, the data is interactively offloaded at a block 54. It at a decision block 56, all the data is offloaded, the data is sent to the receiving device at block 52. While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. A method of offloading data recorded on a flight recorder, the method comprising:
determining whether to enable a wireless transmitter; and
wirelessly transmitting previously stored data on the flight recorder via the wireless transmitter according to the determination.

2. The method of claim 1, wherein wireless transmission is performed in accordance with a wireless protocol.

3. The method of claim 2, wherein the wireless protocol includes at least one of an 802.11 specification, GSM-GPRS and CDMA.

4. The method of claim 1, wherein determining is based upon one or more airplane parameters.

5. The method of claim 4, wherein the one or more airplane parameters includes at least one of weight on wheels, air speed, ground speed, engine speed, open compartments, and sensed forces.

6. The method of claim 1, wherein transmitting includes at least one of automatically and manually offloading wireless data.

7. The method of claim 6, wherein manually offloading includes interactively offloading the stored data.

8. The method of claim 1, wherein the wireless transmitter includes at least one of a PCMCIA card and an antenna.

9. An apparatus for wirelessly offloading data recorded on a flight recorder, the apparatus comprising:
a processor configured to determine whether to enable wireless transmission; and
a wireless transmitter coupled to the processor, configured to wirelessly transmit previously stored data from the flight recorder.

10. The apparatus of claim 9, wherein the processor further comprises at least one aircraft parameter component for determining whether to enable wireless activation.

11. The apparatus of claim 10, wherein the aircraft parameter component further comprises one or more aircraft parameter.

12. The apparatus of claim 11, wherein the one or more aircraft parameter includes at least one of weight on wheels, air speed, ground speed, engine speed, open compartments, and sensed forces.

13. The apparatus of claim 9, wherein the wireless transmitter transmits according to at least one of an 802.11, GSM-GPRS, and CDMA protocols.

14. The apparatus of claim 9, further comprising a wireless receiving device configured to receive wireless data, including at least one of a PCMCIA card and an antenna.

15. The apparatus of claim 9, further comprising:
a memory device for storing data; and
a circuit connector coupled to the memory device and the processor, the connector configured to send data from the processor to the memory device for storage.

16. The apparatus of claim 9, wherein the processor further includes an encryption component for encrypting data.

17. A computer product residing on a computer readable storage medium, the product comprising:
a first component configured to determine whether to enable wireless transmission; and
a second component configured to wirelessly transmit previously stored data from the flight recorder to wirelessly offload data recorded on a flight recorder.

18. The product of claim 17, wherein the first component further comprises a wireless parameter component for determining whether to enable wireless activation.
